(19) United States
(12) Patent Application Publication
(10) Pub. No.: US 2003/0118145 A1
(43) Pub. Date: Jun. 26, 2003

(54) Multiple chamber containment system

(76) Inventors: Sadeg M. Faris, Pleasantville, NY (US); Tsepin Tsai, Chappaqua, NY (US)

Correspondence Address: Reveo, Inc., 85 Executive Blvd., Elmsford, NY, 10523, US

(21) Appl. No.: 10/282,936

(22) Filed: Oct. 29, 2002

Related U.S. Application Data
(63) Continuation-in-part of application No. 09/570,598, filed on May 12, 2000, now Pat. No. 6,359,953.
(60) Provisional application No. 60/340,592, filed on Oct. 29, 2001.

(51) Int. Cl. G21C 19/00

(52) U.S. Cl. 376/268

(57) ABSTRACT

A container is provided generally including a first portion configured for containing a first substance and a second portion configured for containing a second substance. The first substance is applied to process, generally for production of a useful byproduct. Further, the second substance may be a useful byproduct of the process, or may be a different byproduct of the process. The volume of the first portion may be variable, the volume of the second portion may variable, or the volumes of the first portion and the second portion may be variable, such that the first portion and the second portion fit within the total volume of the container.

### RELATED CASES

The present application claims priority to U.S. Provisional Application Serial No. 60/340,592, filed Oct. 29, 2001, entitled “Multiple Chamber Containment System”; and is a Continuation in Part of U.S. patent application Ser. No. 09/570,598 filed on May 12, 2000 entitled “Fuel Containment and Recycling System”, which is incorporated by reference herein in its entirety.

### BACKGROUND OF THE INVENTION

1. Field of the Invention

The present invention relates generally to containment systems, and particularly containment systems configured for delivering and collecting substances.

2. Description of the Prior Art

Many systems require one or more input containers and one or more output containers to carry out operations. For example, chemical processes and electrochemical processes typically have one or more input substances from individual containers and one or more output substances from individual containers.

Chemical processes, such as organic and inorganic chemical synthesis, electrical generating reaction, material synthesis, bioreactions, etc., all require use of one or more input substances and result in one or more output substances. For example, bioreaction is generally a process whereby organisms act on an input substances to convert it to a varied output substances. For example, wastewater treatment commonly uses aerobic and anaerobic bacteria to remove contaminants from wastewater by causing waste species to settle for facilitating removal.

The synthesis of many chemicals, including organic chemicals, inorganic chemicals, and various combinations thereof, generally involve input of one or more substances into a reactor to form the desired output substances or product. In most situations, byproducts also form. The systems provide vessels or other containments for each input substances and each product, as well as any byproducts that may be formed, if necessary. Therefore, the various vessels or other containers increase the total area of space required to store the system. This space is essentially wasted when the vessels, such as the output vessel, is empty as in the case when the process is not yet begun, or when he input substances vessels are empty, as in the case when the process is completed. Furthermore, certain systems are configured such that the inherent pressure of the input substances in the vessel creates a portion at least a portion of the force to transport that substance to the reactor. As the volume is decreased in the vessel, the pressure of the substances leaving its vessel is decreased.

Electrical generating processes generally convert one or more substances into a byproduct substance while producing usable energy. Typical electrochemical systems include fuel cells, such as metal air fuel cells, hydrocarbon based fuel cells, such as proton exchange membrane based fuel cells, and solid oxide fuel cells. Additionally, various biological processes produce usable energy, generally utilizing enzymes and glucose based substances as fuel. Furthermore, various battery systems are known, which are essentially fuel cells contained such that the fuel supply is limited, particularly, certain batteries use fluid anolytes and catholytes.

Metal air fuel cells are based on electrochemical conversion of the metal, such as zinc or lithium, into an oxide of that metal in the presence of air and a caustic electrolyte. Various systems for metal air fuel cells are described in, for example, copending, commonly assigned, U.S. patent application Ser. No. 09/578,798 entitled “Fuel Containment and Recycling System” by Faris et al., and filed on May 12, 2000, the entire disclosure of which is incorporated by reference herein.

Solid oxide fuel cells are typically based upon hydrocarbon fuels such as methanol in combination with water. These fuels are consumed to produce electrical energy and water as a byproduct. Typically, the fuel may be provided as a mixture, and the byproduct may be discharged or stored. Storing a byproduct in a separate vessel is not practical in many applications, such as automotive applications, due to space constraints. Many applications reintroduce the byproduct into the fuel mixture. This, however, dilutes the fuel mixture and decreases fuel efficiency of the fuel cell operations.

Another hydrogen based fuel cell employees a hydrogen source such as a sodium boron hydride. Such cells are disclosed, for example, in U.S. Pat. No. 5,948,558 entitled “High energy density boride batteries” and U.S. Pat. No. 5,804,329 entitled “Electroconversion Cell”. Generally, sodium boron hydride is mixed with water to release hydrogen for conversion into useful energy, whereby a sodium boron oxide is provide produced as a byproduct.

An additional type of electrochemical device is a redox cell, were a metal and halide are provided as anolytes and catholytes, respectively, and reacted in the presence of electrolyte to produce electricity. Conventionally, anolyte and/or catholyte is either continuously fed, or is operated in batch mode with dilution throughout the course of the electrochemical reaction.

Many of the aforementioned systems, as well as many other systems, must employ a plurality of containers occupying separate volumes to separate different substances. Other systems that do not occupy separate volumes for the process substances sacrifice efficiency as they allow the reacted substances to decrease in concentration.

A system has been described, particularly for metal air fuel cells, for solving the aforementioned problem, and is fully disclosed in copending, commonly assigned U.S. patent application Ser. No. 09/570,598 filed on May 12, 2000 entitled “Fuel Containment and Recycling System”, which is incorporated by reference herein in its entirety. While the aforementioned application claims a system that covers many of the systems described further herein, the present disclosure is provided to further detail various embodiments falling within the scope of these claims as well as other embodiments.

### SUMMARY OF THE INVENTION

The above-discussed and other problems and deficiencies of the prior art are overcome or alleviated by the several methods and apparatus of the present invention, wherein a container is provided including a first portion configured for containing a first substance and a second portion configured for containing a second substance. The first substance is applied to process, generally for production of a useful byproduct. Further, the second substance may be a useful byproduct of the process, or may be a different byproduct of the process.

Generally, a primary advantage of the container is that the first substance and the second substance may be stored in a volume that is preferably the same volume as the larger of the volumes of the first substance or the second substances. This is very useful, for example, in transportation systems, such as automobiles, airplanes, space crafts, water vessels, or the like; satellite systems; buildings; personal devices; and other systems wherein it is desiderate to reduce volume.

In various embodiments, the byproduct generates usable energy, typically in the form of electricity. In further embodiments, the useful byproduct is a thermal byproduct, such as a temperature increase or decrease. In additional embodiments, the useful byproduct is a substance, such as a chemical substance. In various other embodiments, the useful byproduct is mechanical energy. In still further embodiments, the useful byproduct is light.

The above-discussed and other features and advantages of the present invention will be appreciated and understood by those skilled in the art from the following detailed description and drawings.

### BRIEF DESCRIPTION OF THE DRAWINGS

FIG. 1 is a schematic of one embodiment of a multiple chamber containment system having an input substance portion and an output substance portion operatively coupled to a process;

FIG. 2 is another embodiment of a multiple chamber containment system including a treatment step;

FIG. 3 is an embodiment of a configuration of a pair of multiple chamber containment systems coupled to a process;

FIG. 4 is an embodiment of a multiple chamber containment system employing additional inputs (outside of the multiple chamber containment system);

FIG. 5A is an embodiment of a multiple chamber containment system having a pair of input substance portions;

FIG. 5B is another embodiment of a multiple chamber containment system having a pair of input substance portions, one of which circulates with the process;

FIG. 6 is an embodiment of a multiple chamber containment system having a pair of output substance portions;

FIGS. 7A and 7B show one embodiment of a structure for a multiple chamber containment system;

FIGS. 8A and 8B show another embodiment of a structure for a multiple chamber containment system;

FIGS. 9A and 9B show a further embodiment of a structure for a multiple chamber containment system; and

FIGS. 10A and 10B show still another embodiment of a structure for a multiple chamber containment system;.

### DETAILED DESCRIPTION OF THE ILLUSTRATIVE EMBODIMENTS

Herein disclosed is a container for containing a plurality of substances, particularly an input substance and an output substance, wherein the terms “input” and “output” are generally relative to an associated process. The container includes a first portion configured for containing a first substance and a second portion configured for containing a second substance. The first substance is applied to process, generally for production of a useful byproduct. Further, the second substance may be a useful byproduct of the process, or may be a different byproduct of the process.

The processing may comprise a variety of operations. Generally, any required processing step may be carried out on one or more input substances, to produce one or more output substances. For example, the processing may be a condenser or liquefier used to convert a gas to liquid or compressed gas. Alternatively, the processing may be a transport step, such as a pump. In this manner, the treatment serves to displace the one or more fluids into the one or more portions of the container. Furthermore, the processing may be a separation, such as a crystallization operation or a distillation operation. In this manner, the processing may have additional inputs and/or outputs witch or not contained within the container. Additionally, the processing may comprise a compaction apparatus, to compact a solid or solid/liquid mixture for further volume conservation.

The processing step may also comprise an electrochemical cell, wherein one or more input substances serve as consumable electrode materials. Further, this electrochemical cell may comprise plural electrochemical cells. In this manner, multiple electrochemical cells may be activated in series or in parallel to provide varying voltage and/or current levels.

The container has a total volume, which may be defined by one or more rigid or flexible walls. The container includes a first portion for containing a first substance and a second portion for containing a second substance. The volumes of the first, second, or both the first and second portions are variable, such that the first portion and the second portion fit within the total volume. In one embodiment, the volume of the first portion and the volume of the second portion are inversely variable. In another embodiment, a movable barrier separates the first portion and the second portion. An external force, such as a human force or a mechanical force, may displace the barrier. Displacement of the barrier may be activated by electricity, a chemical injection, heat, light, etc. The structures may also be, for example, suitable material bags capable of expanding and collapsing, as well as being inert and chemically stable with the desired substances to be contained.

Further, the barrier itself may comprise a process, for example, allowing fluid or solid communication between portions of the container. For example, electrolyte membranes, electrodes, permeable membranes, filters, or other structures or materials may be included in or on the barrier to transform material from one portion into a different material or different state for containment in the other portion.

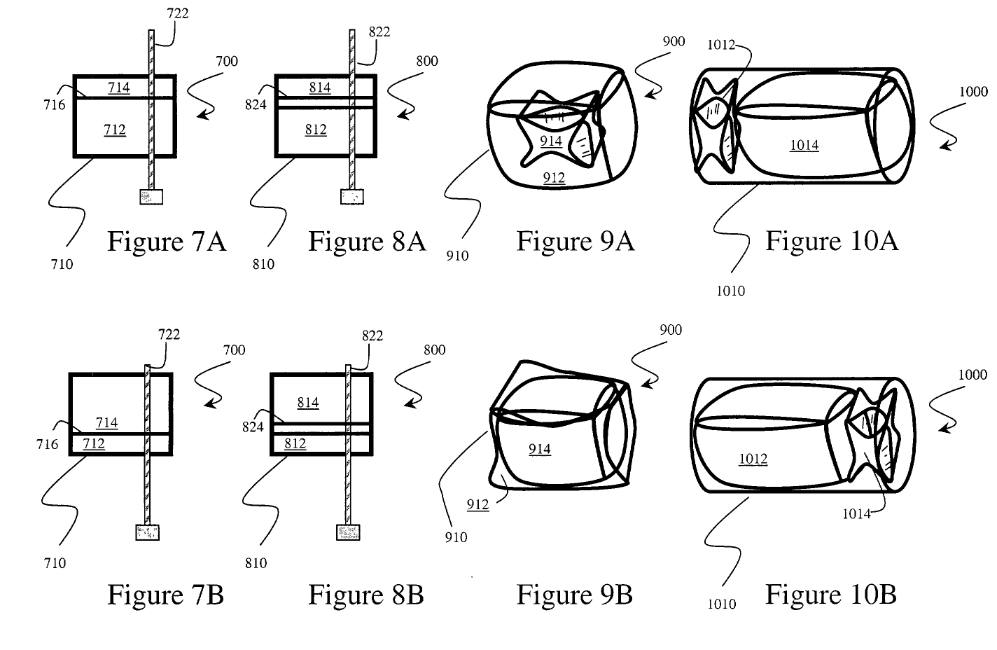

The containers described herein may be similar to those described in copending U.S. patent application Ser. No. 09/570,798 entitled “Fuel Containment and Recycling System” filed on May 12, 2000 by Sadeg M. Faris, Tsepin Tsai, Wayne Yao and Yuen-Ming Chang, which is incorporated by reference herein in its entirety. Various exemplary of container structures are schematically depicted in FIGS. 7A and 7B, 8A and 8B, 9A and 9B, and 10A and 10B.

FIG. 7A shows a container 710 having a first portion 712 and a second portion 714 separated by a movable barrier 716, e.g., movable with assistance of a structure 722, which may comprise a helical screw, a linearly actuated device, or the like. FIG. 7B shows container 710 having a larger volume in the second portion 714, due to movement of the barrier 716.

FIG. 8A shows a container 810 having a first portion 812 and a second portion 814 separated by a movable processing barrier 824, e.g., movable with assistance of a structure 822, which may comprise a helical screw, a linearly actuated device, or the like. FIG. 8B shows container 810 having a larger volume in the second portion 814, due to movement of the barrier 816. In the container 810, an associated process, examples of which are also described further herein, converts material from one portion into a different material or a different state, while also serving as a barrier to maintain separate containment.

FIG. 9A shows a container 910 having a second portion 914 and a first portion 912, wherein the volume of the first portion 912 is defined by the space between the inner walls of the container 910 and the outer walls of the second portion 914. FIG. 9B shows container 910 having a larger volume in the second portion 914, due to filling with a substance, and accordingly the volume of the portion 912 is decreased.

FIG. 10A shows a container 1010 having a first portion 1012 and a second portion 1014 in inversely variable volume relationship within the container 1010. FIG. 10B shows container 1010 having a larger volume in the first portion 1014, due to filling with a substance, and accordingly the volume of the portion 1014 is decreased.

The substances in the first and second portions may be the same or different. In a system with same substance in first portion and second substance, for example, the substance from the first portion can be controllably provided to one or more batch processes, for example, as a carrier. Other sources, or a third portion within the container, provide a carrier substance, which is acted on in the process. The carrier substance is then stored in the second portion upon completion of the batch operation.

In a system with different substances, the first substance and the second substance may be completely different, for example, for use in a particular process that combines the substances. Alternatively, the first substance may be used by the process to derive the second substance, for example, in a process that modifies the first substance to form the second substance. Note that the first substance may be modified by processing alone (e.g., application of electrical power, temperature, pressure, filtration, purification), mixture or reaction with another substance (which may be stored or fed from another portion in the container or a source outside of the vessel), or both processing and combination with another substance.

The substances used in the various portions may be any desired substance, and in various combinations. The first substance may include a solid, liquid, gas, or a combination of phases, of any material in which multiple chamber configurations may be utilized. Likewise, the second substance may include a solid, liquid, gas, or a combination of phases, of any material produced by the process. Thus, the various combinations of first substance/second substance are shown in Table 1:

TABLE 1
Phase Combinations of first and second substances

| | First Portion Contents | | | | | |
|---|---|---|---|---|---|---|
| Second Portion | | Gas- | | | Liquid- | |
| Contents | Gas | Liquid | Gas-Solid | Liquid | Solid | Solid |
| Gas | x | x | x | x | x | x |
| Gas- | x | x | x | x | x | x |
| Liquid | | | | | | |
| Gas- | x | x | x | x | x | x |
| Solid | | | | | | |
| Liquid | x | x | x | x | x | x |
| Liquid- | x | x | x | x | x | x |
| Solid | | | | | | |
| Solid | x | x | x | x | x | x |

Referring now to the drawings, illustrative embodiments of the present invention will be described. For clarity of the description, like features shown in the figures shall be indicated with like reference numerals and similar features as shown in alternative embodiments shall be indicated with similar reference numerals.

Multiple Chamber System 100

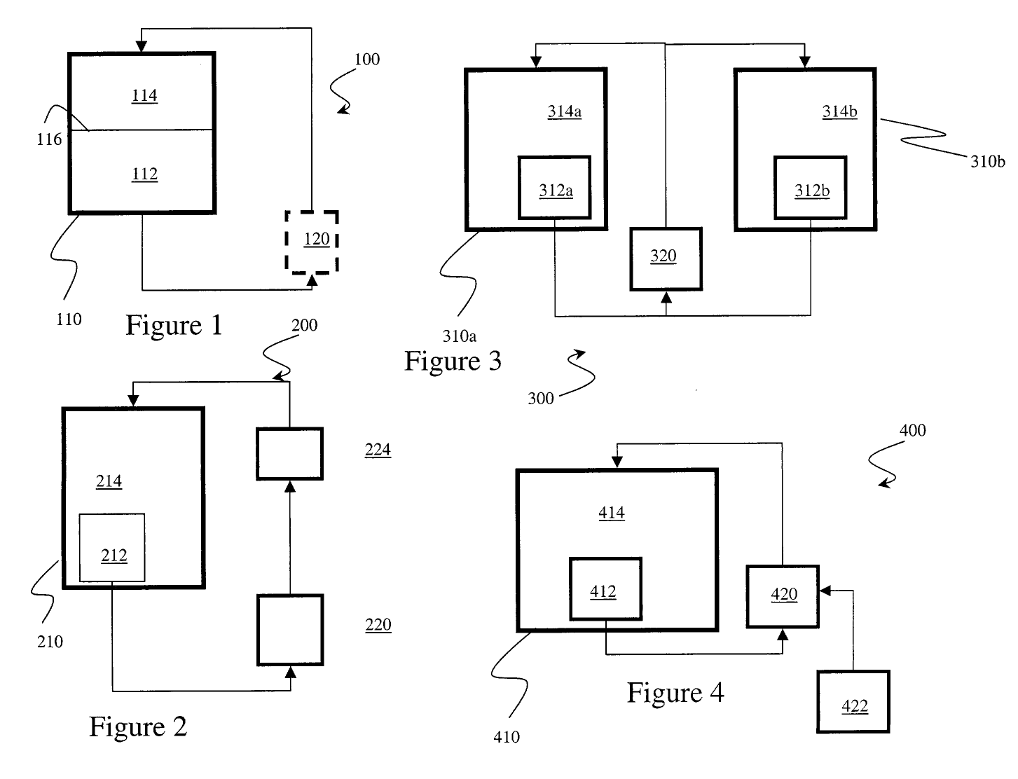

Referring now to FIG. 1, a schematic of a system 100 incorporating a container herein is described. The system 100 includes a container 110 having a first portion 112 and a second portion 114. A first substance, or in this embodiment an input substance, is contained in the portion 112.

The first substance is provided to or subjected to a process 120, which may be a separate physical structure, a phenomenon of the first substance residing in the first portion 112 (hereinafter referred to as a phenomenon of residence), or a combination thereof. Accordingly, process 120 is indicated in dashed lines, representing the fact that the process 120 may be a separate structure, integral within the container 110, or a phenomenon of residence. The process 120 results in a second substance, or a product, which is contained in the second portion 114 of the container 110. The process 120 may produce one or more various byproducts, such as electricity, heat, chemical, mechanical, or light.

During operation of the process 120, at least a quantity of the first substance in portion 112 is consumed or transported, and at least a portion is converted into the second substance and contained in the second portion 114. Additional substances (not shown) may be incorporated into the process 120. As the second substance is created, it is introduced into the second portion 114 of the container 110. A barrier 116 separates the first portion 112 and the second portion 114. At the commencement of the operation of the process 120, the volume of the portion 114 may be minimized, (i.e., it may approach, or reach zero) by operation of the barrier 116. During operation, as a first substance is consumed and the second substance is produced, the barrier 116 may move (e.g., by mechanical means, expansion, etc.) thereby creating available volume for the second substance in the portion 114. Alternatively, instead of a barrier 116 (or in conjunction therewith in containers having more than two chambers, for example), the first portion 112 and the second portion 114 may be separate containers within the container 110 (e.g., expandable and collapsible to accommodate volume variation).

In systems, for example, where no additional substances are introduced into the process 120, the volume of the container 110 may equal the greater of the volume of the input substance or the output substance throughout operation of the process 120.

First Electrochemical Cell Embodiment of a Multiple Chamber System 100

In one embodiment of a system that generally follows the schematic of system 100, process 120 comprises an electrochemical cell such as a metal air cell. The first substance, which is fed to the cell from portion 112, under a continuous or in a batch process, comprises a metal fuel such as a metal paste having electrolyte therein (e.g., zinc, magnesium, aluminum, or any other oxidizable metal). Upon operation of the metal air cell, the metal fuel is converted to into a metal oxide, which is stored in portion 114 of the container 110 as the second substance. The metal oxide may be stored in a batch or continuous fashion. The useful byproduct of the metal air cell is the electricity, which is harnessed for external use (not shown).

Where the process 120 comprises an electrochemical cell such as a metal air cell, the container 110 may be a portable device, for example, suitable for laptop computers, cellular phones, power tools, other handheld devices, small transports devices such as scooters, etc. Further, container 110 may be integral with a system such as a land, water, or air vessel. Additionally, container 110 may be integral within an on-site power generation system.

In a further embodiment, the process 120 may actually comprise several electrochemical cells. The connection between the portion 112 of the container 110 may have plural branches, that are separately connected to the plural electrochemical cells. Using suitable mechanical or fluid flow controls, such as valves, the metal fuel may be selectively transported to one or more of the connected plural electrochemical cells, forming cell systems of varying voltage and/or current. In addition, a controller may be incorporated, generally to determine which of the plural electrochemical cells should be activated (i.e., fed metal fuel).

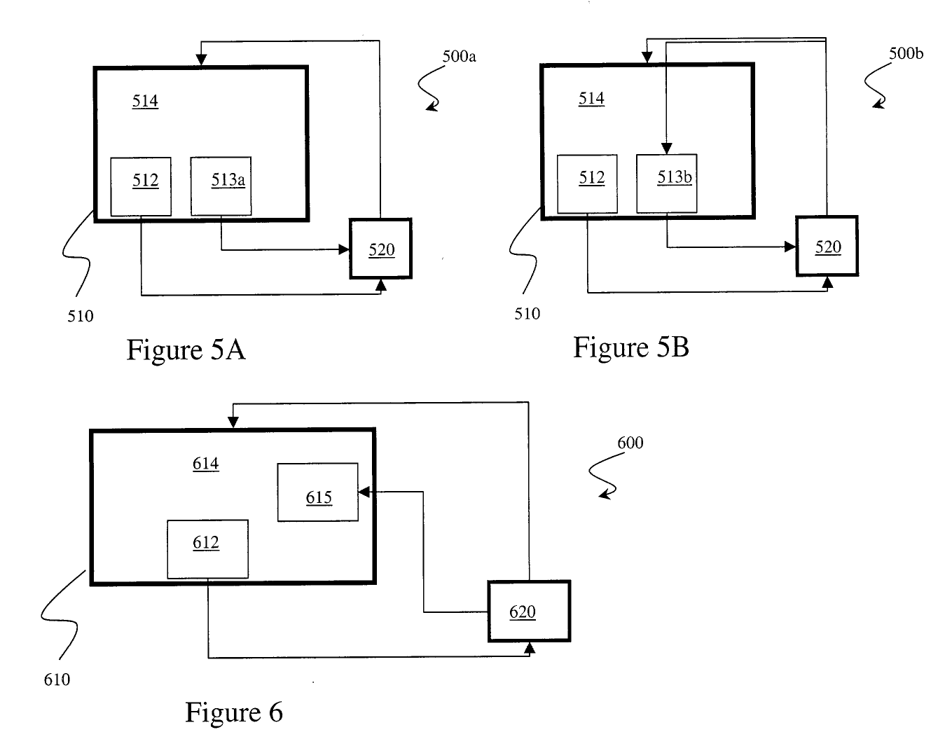

In a further alternative (and referring to FIG. 5B) the metal fuel may be circulated through one or more electrochemical cells (process 520) more than one time, in order to obtain maximum capacity from the metal fuel. For example, metal fuel as the first substance in portion 512 may be fed to the cell (process 520). Initially, when the “exhaust” still has electrochemical capacity remaining, it may be exhausted to a portion 513b, and circulated back to the cell. The partially used fuel from portion 513b may be circulated through the process 520 repeatedly, until it is determined (e.g., via an associated controller, voltage sensor, or the like) that the capacity is minimized. This will ensure the highest possible depth of discharge of the metal fuel. When the capacity of the metal fuel is minimized, then it may be outputted as final exhaust to portion 514.

The metal oxide may be recharged by applying electrical current thereto. In rechargeable systems, after recharging the material (i.e., wherein the material remains within, or is returned to, its respective portion 112 or 114), further discharge is via the “second substance” from the portion 114 as the fuel of the metal air cell, wherein metal oxide formed from the process 120 may be stored in the first portion 112.

Second Electrochemical Cell Embodiment of a Multiple Chamber System 100

In another embodiment of a system following the general schematic of system 100, a methanol fuel cell is the process 120. The first substance, in this case methanol or methanol in combination with water, is contained in the first portion 112. During operation of the fuel cell, generally continuous operation, the exhaust from the fuel cell (primarily water) is stored as the second substance in the second portion 114 of the container 110. In this fashion, the exhaust, which is typically contaminated to some degree, is stored rather than the discharged into the environment, while maintaining volume conservation. Furthermore, during operation of the fuel cell, the methanol or methanol and water mixture remains at a constant concentration within the first portion. An additional reactant to the direct methanol fuel cell system is oxygen, generally provided from the air, and the useful byproduct of the direct methanol fuel system is electricity.

Third Electrochemical Cell Embodiment of a Multiple Chamber System 100

An additional embodiment of a system following the general schematic of system 100 includes a process 120 comprising a redox fuel cell. The first substance, which is provided to the cell from the first portion 112, comprises an anolyte, for example, a zinc solution. Upon operation of the process 120 (i.e., operation of the redox cell), the anolyte reacts with a catholyte in the presence of electrolyte. A portion of the zinc in the anolyte solution is converted to zinc oxide, and remains in solution. The consumed anolyte is stored in the second portion 114 as the second substance.

In another example of the redox cell, the catholyte may comprise the first substance, such as a bromine solution. Upon operation of the redox cell, the bromine is generally converted to bromide ions and is stored to in the second portion 114 as the second substance.

Fourth Electrochemical Cell Embodiment of a Multiple Chamber System 100

Still another embodiment of the system that follows the general schematic of system 100 utilizes a process 120 including a bio-electrochemical process. Typical bio-electrochemical processes use an oxidizable organic compounds as a fuel. Various enzymes are also typically provided to enhance electrochemical reaction. The oxidizable organic compounds may comprise carbohydrates such as glucose. Many systems require pure or substantially pure glucose, to minimize or prevent production of the byproduct that cannot be converted to into energy.

Therefore, in a bio-electrochemical cell system herein, a glucose containing substance may be provided in the first portion 112. Various mechanical devices may be used to collect the glucose containing substance (e.g., grass). For example, a cutting blade or mechanism may cut and feed the glucose containing substance, whereupon it is stored in the first portion 112, and consumed by the bio-electrochemical process 120. As the waste, or non consumed portion of the first substance, is produced from the bio-electrochemical process 120, it may be stored in the second portion 114 of the container 110. One example of a useful system employing such a bio-electrochemical cell is a self-fueled device that is capable of consuming, or cutting, grass. As the grass is consumed, glucose from the grass provides electrical energy to cause the self-fueled device to move and continue to cut the grass, and further to control any provided system electronics. The waste may be stored as the second substance within the portion 114. Since the fuel may be stored in the portion 112, as well as be directly consumed by the process 120, the system may be self powered, even at regions where no grass or other glucose containing substance exists. When the portion 114 is filled such that less than a desired volume of the portion 112 remains, portion 114 may be emptied, for example, at a compost heap.

First Processing Embodiment of a Multiple Chamber System 100

In another embodiment of a system 100, the first portion 112 of the container 110 contains a decomposable substance, such as biomass. Here, the process 120 may include a phenomenon of residence or a separate or integral active process, such as heat and/or pressure. The second substance may include methane, a gaseous by-product of the decomposition of the biomass. Thus, this methane may be collected in the second portion 114, which can be an expandable collection container within the container 110 or a portion of the container 110 separated from the first portion 112 by the barrier 116. For example, a one way valve (e.g., requiring a certain gas pressure to open in one direction) may be include to allow methane to enter into the second portion from the first portion, but not exit the second portion into the first portion.

Second Processing Embodiment of a Multiple Chamber System 100

Another embodiment of a system 100 includes oil processing, such as refining of crude oil into various fractions and/or derivatives. For example, crude oil may be maintained in the first portion 112 of container 110. The process 120 may include distillation, cracking, or a combination thereof. Upon processing, the product, for example, gasoline, may be stored in the second portion 112. Thus, as crude oil is processed from the first portion 112, the volume of the first portion 112 decreases. Accordingly, the volume of the second portion 114 increases as gasoline is created and stored in the second portion 114.

Third Processing Embodiment of a Multiple Chamber System 100

Another embodiment of a system 100 includes water processing, such as purification of water for water supply or purification of wastewater. For example, water to be purified may be maintained in the first portion 112 of container 110. The process 120 may include one or more water treatment process steps. Upon processing, the product, for example, purified or partially purified water, may be stored in the second portion 112. Thus, as water is processed from the first portion 112, the volume of the first portion 112 decreases. Accordingly, the volume of the second portion 114 increases as purified or partially purified water is created and stored in the second portion 114.

Multiple Chamber System 200

Referring now to FIG. 2, another schematic of a system incorporating a container herein is described. A system 200 includes a container 210 having a first portion 212 and a second portion 214. A first substance is contained in the portion 212, which may be controllably provided to a process 220. The process 220 results in a second substance which is contained in the second portion 214. The process 220 may produce one or more various byproduct, such as electricity, thermal, chemical, mechanical, light, or combinations thereof.

Prior to being introduced into the second portion 214, the second substance (generally from the process 220) is subjected to a treatment 224. The treatment 224 may transport the second substance, change certain properties of the second substance, such as chemical or physical properties, or a combination thereof. For example, the treatment 224 may comprise a reactor coupled to a pump. Further, the treatment 224 may comprise a physical treatment, for example to condense the substance or separate the substance.

First Combustion Embodiment of a Multiple Chamber System 200

In one embodiment of a system that generally follows the schematic of system 200, process 220 comprises a combustion engine, the first substance comprises the fuel for the compression engine such as gasoline, and the useful byproduct is the mechanical energy of the engine. As the gasoline is consumed, carbon dioxide and other exhaust products exit the engine. These exhaust products may be provided to a treatment 224, such as a condenser, generally to convert the higher volume exhaust gas into a lower volume gas or even a liquid. This treated exhaust is then transported to the second portion 214 of the container 210.

In this manner, a combustion engine may operate with substantially zero emissions. All or a portion of the exhaust is stored in the second portion 214, which may be, for example, a bag or other collection device provided within a tank similar to a conventional fuel tank. As the second substance, or the combustion engine exhaust, increases, the volume of the second portion 214 increases and correspondingly the volume of the first portion 212, which is configured to hold fuel such as gasoline for the combustion engine, accordingly decreases.

The combustion system for containing gasoline and containing exhaust products may be further equipped with an evacuation device in communication with the second portion 214. This evacuation device may be operated to remove exhaust products. Further, the evacuation device can be coupled to an indicator, to indicate when the portion 214 is at a maximum capacity. The evacuation system can be operated manually or automatically. Such an evacuation system can be accessed via, for example, a port proximate to the fuel tank input. In this manner, the container 210 can be filled by filling the portion 212 with fuel and concurrently or consequently emptied in by removing exhaust products from the portion 214 with, for example, a suitable adaptor coupled to a conventional vacuum apparatus.

Second Combustion Embodiment of a Multiple Chamber System 200

Further, using the same principals as the fuel tank for a combustion engine, a container may be adapted for providing fuel (as the input substance) to a combustion process for generating thermal by-product, whereby ash and other combustion exhausts may be captures and stored as the output substance.

Multiple Chamber System 300

Referring generally to FIG. 3, a system 300 comprises a first container 310A for a first input and a first output substance contained in portions 312A, 314A, respectively, and a second container 310B for a second input and a second output substance contained in portions 312B, 314B, respectively. Barriers 316A and 316B are provided in the respective cells. Both the first and second input substances are provided to the same process 320 (which may be provided at various rates and/or intervals), which results in the first and second output substances. As the first and second output substances are produced, the barriers 316A and 316B accordingly are displaced (by the force of the fluid, by an external force, or a combination thereof).

First Electrochemical Cell Embodiment of a Multiple Chamber System 300

In one embodiment of a system following the general schematic of system 300, process 320 comprises a redox cell, which operates similar to the example described above. The first container 310A contains the anolyte input and output, and the second container 310B contains the catholyte input and output. Both fluid streams are provided to the redox cell.

In the redox cell, with one or more multiple chamber containers, the cell always be operating with fresh material. The cell may be controllable such that the anolyte and/or catholyte is received in individual stages, or the anolyte and catholyte may be released continually. As such, electronic integration may be applicable.

Second Electrochemical Cell Embodiment of a Multiple Chamber System 300

In another embodiment of a system following the general schematic of system 300, process 320 comprises a Vanadium redox cell¹. The first container 310A contains the anolyte input and output, and the second container 310B contains the catholyte input and output. Both fluid streams are provided to the redox cell. ¹ For example, see Status of the Vanadium Redox Battery Development Program, C. Menictas et al., Vanadium Battery Development Laboratory, School of Chemical Engineering and Industrial Chemistry, The University of New South Wales, PO Box 1 Kensington NSW 2033, Australia (http://www.ceic.unsw.edu.au/centers/vrb/eec94a.htm), Mar 17, 1998.

The catholyte reacts at cell 320 according to the following half-cell reaction:

V⁵⁺+e⁻ [symbol] V⁴⁺.

The anolyte reacts at cell 320 according to the following half-cell reaction:

V²⁺ [symbol] V³⁺+e⁻.

Multiple Chamber System 400

Referring now to FIG. 4, a system 400 is provided comprising a container 410 coupled to a process 420. The container 410 has a first portion 412 for holding a first substance, which is generally is the input to the process 420, and the second portion 414 for containing a second substance, which is generally the output or exhaust of the process 420. Additionally, a source 422 provides an additional input substance to the process 420. The additional input substance from the source 422 may: become part of the output substance contained in the second portion 414; be converted into a portion of the useful byproduct (e.g., electricity, thermal, chemical, mechanical, or light); be removed from the process 320 separately; or a combination thereof.

Electrochemical Cell Embodiment of a Multiple Chamber System 400

In one embodiment of system that generally follows the schematic of system 400, the process 420 comprises a hydrogen based fuel cell. The first substance comprises a source of hydrogen, which is releasable upon reaction in the presence of a catalyst, which is provided from the source 422. For example such hydrogen source is sodium borohydride (NaBH₄)). As the first substance, sodium borohydride may be provided in solution with water. Upon reaction in the presence of a catalyst, hydrogen gas is released from the sodium borohydride and consumed by the fuel cell to produce electrical energy, and sodium borate (NaBO₂) is produced as a byproduct. This byproduct, which may be in solution with water, is contained in the second portion 412 of the container 410.

Multiple Chamber System 500a

Referring now to FIG. 5A, a system 500a using a container 510 coupled to a process 520 is depicted. The container 510 comprises the first portion 512 having a first substance, and the second portion 513a having a second substance, which both generally provide input substances to process 520. The first and second inputs substance may be released to the process 520 at various rates and intervals, which may be the same or different from each other. The output of the process 520, a third substance, is provided to a portion 514 of the container 510.

First Processing Embodiment of a Multiple Chamber System 500a

One embodiment of a system that generally follows the schematic of system 500a is a chemical synthesis process. The first reactant and the second reactant comprise the first substance and the second substance, respectively. The process 520 comprises a reactor, and when the first and second reactants are introduced into the reactor, a product, or the third substance, is formed. In this manner, one container can be used to store multiple reactants and a single product. Furthermore, the reactor may produce other products. Such other products may be contained within an additional portion of the container 510 (not shown), or may be stored separately. Furthermore, these additional products may be a byproduct of the system, which is separately contained. Also, the third substance may comprise a useful by-product that is subsequently removed from the portion 414 for further disposition.

Second Processing Embodiment of a Multiple Chamber System 500a

A specific embodiment of a chemical synthesis using system 500a include water gas shift reactions. In typical water gas shift reactions, carbon monoxide plus water react to produce carbon dioxide and hydrogen. Thus, in system 500a, the first portion 512 includes carbon monoxide and the second portion 513a includes water. To form carbon dioxide and hydrogen, the contents of the first portion 512 and the second portion 513a are fed to the process 520. The process 520 is typically at elevated temperatures, and over one or more catalysts. The resultant mixture of carbon dioxide and hydrogen is then stored in the third portion 514. Accordingly, as the reactants (carbon monoxide and water) form the products (carbon dioxide and hydrogen), the volume of the container 510 may remain constant, since portions 512 and 513 contract, and portion 514 expands.

Third Processing Embodiment of a Multiple Chamber System 500a

In another embodiment of a system employing the general schematic of system 500a, the useful byproduct may be light, wherein the process 520 comprises a transparent mixing chamber for mixing the first and second substances. The first and second substances are chemicals that, when combined, produce light. For example, U.S. Pat. No. 4,859,369 (the “'369 patent”), incorporated by reference herein, describes the use of water-soluble polymers in aqueous chemical light formulations. In the '369 patent, an aqueous solution of 4,4′-oxalylbis [(trifluoromethylsulfonyl)imino]ethylene]-bis[4-methylmorpholinium trifluoromethane-sulfonate], referred to as METQ, is mixed with poly(vinylpyrrolidone) and fluorescer rubrene sulfonate. Aqueous hydrogen peroxide is then added, which, when mixed, is capable of producing a bioluminescent material. Note that any or all of the reactants may be stored as the first substance and the second substance in the container 500, or a similar container having additional portions for holding more than two reactants. The produced bioluminescent material is stored, for example, as depicted in FIG. 5, as the third substance in the portion 514 of the container 510. To provide continuous light, reactants (e.g., stored as the first and second substances) may be released from the container (e.g., the first and second portions 512, 513a). In this manner, a continuous light source may be provided to using a single container for containing all or a portion of the reactants and product.

Fourth Processing Embodiment of a Multiple Chamber System 500a

The light producing system is readily adaptable to provide thermal energy, such as by chemical reactions as are used in various hot and cold packs, whereby chemicals are mixed to provide hot or cold temperatures. Again, a continuous process may be effectuated, whereby an extended time period of useful by-product production may coexist with safe and convenient storage of the reaction product for recycling or proper disposal.

Multiple Chamber System 600

Referring now to FIG. 6, a system 600 is depicted including a container 610 having an input to a process 620, whereby the process 620 outputs a plurality of substances. The input substance is contained in a portion 612, and the output substances are contained in portions 614, 615.

First Processing Embodiment of a Multiple Chamber System 600

One embodiment of a system that generally follows the schematic of system 600 is a water electrolysis process. The input substance, water to by electrolyzed, is contained in the portion 612. The water is subjected to an electrolysis process 620, wherein it is split into the output substances hydrogen and oxygen, and separately contained in portions 614, 615.

Second Processing Embodiment of a Multiple Chamber System 600

Another embodiment of system 600 is a deionization process such as a water desalination process. Sea water is stored in chamber 612. The reactor 620 can be any technology known to the art. For example, reverse osmosis, electrodialysis, or one or more flow through capacitors may comprise the process/reactor 620. These processes produced salt concentrated water and fresh water. The concentrated water can be collected in chamber 615 and fresh water can be stored in chamber 614.

Third Process Embodiment of a Multiple Chamber System 600

System 600 can be applied to compact alkali-chloro generation process. Salt water can be stored in chamber 612. The reactor 620 may comprise an electrochemical cell with two electrodes. On one electrode, chlorine gas is generated and it can be stored in chamber 615. The left over liquid is NaOH, which can be stored in Chamber 614.

A primary benefit derived from the systems described herein is conservation of volume. In general, the volume of the overall storage container may be preserved for the largest volume for either the input substance or the output substance.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A system for containing a plurality of substances including a container having a total volume, the container comprising:
a first portion for containing a first substance; and
a second portion for containing a second substance,
wherein the volume of the first portion is variable, the volume of the second portion is variable, or the volumes of the first portion and the second portion are variable, such that the first portion and the second portion fit within the total volume.

2. The system as in claim 1, wherein the volume of the first portion and the volume of the second portion are inversely variable.

3. The system as in claim 1, wherein the first portion and the second portion are separated by a movable barrier.

4. The system as in claim 1, wherein the first substance and the second substance are substantially the same.

5. The system as in claim 1, wherein the first substance and the second substance are different.

6. The system as in claim 1, further comprising partial electrochemical cell including a cathode and an ionic medium, the first portion in solid or fluid communication with the partial electrochemical cell, wherein the first substance comprises metal fuel which is fed to the partial electrochemical cell to form an electrochemical cell, and further wherein spent fuel comprises the second substance which is expelled from the electrochemical cell.

7. The system as in claim 1, the first portion in fluid communication with a hydrogen based fuel cell including a first electrode, a second electrode and an electrolyte in ionic communication with the first electrode and the second electrode, wherein the first substance comprises a hydrogen based fuel which is fed to the first electrode of the hydrogen based fuel cell, produces a voltage across the first electrode and the second electrode, discharges unreacted hydrogen based fuel at the first electrode, and produces the second substance comprising water at the second electrode.

8. The system as in claim 7, wherein the unreacted hydrogen based fuel is stored in the first portion.

9. The system as in claim 7, wherein the unreacted hydrogen based fuel is stored in the second portion.

10. The system as in claim 1, further comprising a redox cell including a catholyte, the first portion in spatial/fluid communication with the redox cell, wherein the first substance comprises a feed anolyte which is fed to the redox cell and exhausts the second substance comprising spent anolyte.

11. The system as in claim 1, further comprising a redox cell including an anolyte, the first portion in fluid communication with the redox cell, wherein the first substance comprises a feed catholyte which is fed to the redox cell and exhausts the second substance comprising spent catholyte.

12. A system as in claim 11 combined with a separate system as in claim 12, wherein the system is in claim 12 is the catholyte for the redox cell.

13. The system as in claim 1, further comprising a bio-electrochemical cell, the first portion in fluid communication with the bio-electrochemical cell, wherein the first substance comprises an oxidizable organic compound and a carrier which is fed to the bio-electrochemical cell and exhausts the second substance comprising the carrier.

14. The system as in claim 13, wherein the oxidizable organic compound and the carrier comprises grass, the system further comprising a cutting mechanism for cutting and feeding grass into the bio-electrochemical cell.

15. The system as in claim 14, wherein the cutting mechanism is powered with the bio-electrochemical cell.

16. The system as in claim 14, further comprising a traverse system for movement.

17. The system as in claim 16, wherein the traverse system is powered with the bio-electrochemical cell.

18. The system as in claim 14, further comprising a discharge mechanism for discharging the second substance at a predetermined time or when the second portion has reached a predetermined capacity.

19. The system as in claim 1, the first portion in one way fluid communication with the second portion, wherein the first substance comprises a decomposable substance that decomposes within the first portion and releases fluid by-products which comprise the second substance.

20. The system as in claim 19, wherein the decomposable substance comprises biomass and the fluid by-products comprise methane.

21. The system as in claim 1, further comprising a chemical process system, the first portion in fluid communication with the chemical process system, wherein the first substance is fed to the chemical process system, the chemical process system processing the first substance into the second substance.

22. The system as in claim 21, wherein the chemical process system processes the first substance into the second substance and a third substance.

23. The system as in claim 21, wherein the first substance comprises petroleum.

24. The system as in claim 23, wherein the second substance comprises a petroleum product.

25. The system as in claim 21, wherein the first substance comprises a water feed and the second substance comprises purified water.

26. The system as in claim 1, further comprising an engine, the first portion in fluid communication with a fuel input of the engine, wherein the first substance comprising a fuel selected from the group consisting of gasoline and diesel fuel is fed to the fuel input, the engine producing mechanical energy and the second substance comprising at least a portion of an engine exhaust.

27. The system as in claim 26, further comprising an evacuation system for removing the second substance.

28. The system as in claim 27, further comprising a condenser for condensing the second substance prior to introduction into the second portion.

29. The system as in claim 1, further comprising a furnace, the first portion in fluid communication with the furnace, wherein the first substance comprising fuel is fed to the furnace, the furnace producing thermal energy and the second substance comprising at least a portion of a furnace exhaust.

30. The system as in claim 29, further comprising an evacuation system for removing the second substance.

31. The system as in claim 30, further comprising a condenser for condensing the second substance prior to introduction into the second portion.

32. The system as in claim 1, further comprising a hydrogen based fuel cell receiving hydrogen from a catalytic hydrogen generating system, the first portion in fluid communication with catalytic hydrogen generating system and containing a catalytically releasable hydrogen source which is fed to the catalytic hydrogen generating system producing the hydrogen and the second substance comprising an exhaust.

33. The system as in claim 32, wherein the catalytically releasable hydrogen source comprises sodium borohydride.

34. The system as in claim 1, further comprising a third portion for containing a third substance, wherein the volume of the first portion is variable, the volume of the second portion is variable, the volume of the third portion is variable, the volumes of the first portion and the second portion are variable, the volumes of the first portion and the third portion are variable, the volumes of the second portion and third portion are variable, or the volumes of the first portion, the second portion and the third portion are variable, such that the first portion, the second portion and the third portion fit within the total volume.

35. The system as in claim 34, further comprising a synthesis process, the first portion feeding the first substance to the synthesis process and the second portion feeding the second substance to the synthesis process, wherein the synthesis process outputs the third substance.

36. The system as in claim 34, further comprising a transparent or translucent vessel, the first portion and the second portion in fluid communication with an inlet to the transparent or translucent vessel and the third portion in fluid communication with an outlet of the transparent or translucent vessel, wherein the first substance comprises a first reactant and the second substance comprises a second reactant, the first reactant and the second reactant having properties that emit light upon reaction therebetween, further wherein the third substance comprises the reaction product of the first reactant and the second reactant.

37. The system as in claim 34, further comprising a thermal collection system, the first portion and the second portion in fluid communication with an inlet to the thermal collection system and the third portion in fluid communication with an outlet of the thermal collection system, wherein the first substance comprises a first reactant and the second substance comprises a second reactant, the first reactant and the second reactant having properties that emit heat upon reaction therebetween, further wherein the third substance comprises the reaction product of the first reactant and the second reactant.

38. The system as in claim 34, further comprising a separation system, the first portion in solid or fluid communication with an inlet to the separation system, the second portion in solid or fluid communication with a first outlet of the separation system and the third portion in solid or fluid communication with a second outlet of the separation system, wherein the first substance comprises a substance to be separated into the second and third substance.

39. The system as in claim 1, further comprising a water treatment system, the first substance comprising water to be treated which is fed to the water treatment system, wherein the water treatment system separates treated water from the second substance comprising a treatment waste.

40. The system as in claim 1, further comprising a water treatment system, the first substance comprising water to be treated which is fed to the water treatment system, wherein the water treatment system separates a treatment waste from the second substance comprising treated water.

41. The system as in claim 1, further comprising a water treatment system, the first substance comprising water to be treated which is fed to the water treatment system, wherein the water treatment system separates a treatment waste from the second substance consisting essentially of treated water.

42. The system as in claim 21, the chemical process system comprising a deionization system, the first substance comprising ionized fluid to be deionized that is fed to the water treatment system, wherein the water treatment system separates deionized as a second substance and ionized fluid or solid as third substance.

43. The system as in claim 21, the chemical process system comprising an electrochemical cell with two electrodes, the first substance comprising salt water that is fed to the electrochemical cell, wherein the electrochemical cell separates the salt water into chlorine gas as the second substance and a NaOH solution as the third substance.

44. The system as in claim 6, wherein spent fuel is recirculated through the electrochemical cell plural times to optimize depth of discharge.

45. The system as in claim 6, further comprising a third portion for receiving an initial exhaust from the electrochemical cell as a third substance, said third substance circulated back to the electrochemical cell until electrochemical capacity of said third substance is diminished, whereby the diminished exhaust from the electrochemical cell is the second substance.

46. The system as in claim 6, wherein a plurality of partial electrochemical cells are provided, further comprising a system for diverting the first substance to one or more of the plurality of partial electrochemical cells to provide a series, parallel or series/parallel cell system.
